(19) United States
(12) Patent Application Publication
(10) Pub. No.: US 2006/0053982 A1
(43) Pub. Date: Mar. 16, 2006

(54) ADJUSTABLE WRENCH

(76) Inventor: Yi Huang Mo, Taichung (TW)

Correspondence Address: Yi Huang Mo, P.O. Box 63-298, Taichung, 406, TW

(21) Appl. No.: 10/939,034

(22) Filed: Sep. 13, 2004

(51) Int. Cl. B25B 13/28

(52) U.S. Cl. 81/111

(57) ABSTRACT

An adjustable wrench includes a handle having a fixed jaw, a follower pivotally coupling the handle with one or more levers to allow the follower to be pivoted relative to the handle, a pivotal jaw having one end pivotally coupled to the follower with one or more links, to allow the pivotal jaw to be pivoted relative to the follower, and to allow objects to be grasped between the fixed jaw and the pivotal jaw, and to be driven by the handle in an active direction. The follower may be a gear, and the pivotal jaw may include a number of teeth for engaging with the gear. The handle may also include a number of teeth to engage with the gear.

### BACKGROUND OF THE INVENTION

1. Field of the Invention

The present invention relates to an adjustable wrench, and more particularly to an adjustable wrench for driving fasteners or objects of various sizes or outer diameters.

2. Description of the Prior Art

Various kinds of typical adjustable wrenches and/or plier tool devices have been developed and provided for rotating or actuating or driving fasteners or objects or plumbing tubings of various sizes or outer diameters.

For example, U.S. Pat. No. 5,291,810 to Lins and U.S. Pat. No. 5,351,584 to Warheit disclose two of the typical plier tool devices each comprising two jaws slidably coupled together, and movable or adjustable relative to each other, to rotate or actuate or drive fasteners or objects or plumbing tubings of various sizes or outer diameters.

However, one of the jaws is required to be formed with an oblong or longitudinal hole or channel therein, for slidably receiving a peg that is secured or provided in the other jaw. The formation or the provision of the oblong or longitudinal hole or channels in the jaws may greatly decrease the strength of the jaws, and may have the jaws easily broken or damaged.

U.S. Pat. No. 5,579,667 to Kim discloses one of the typical adjustable wrenches comprising two recesses formed in the head, to slidably or adjustably receive two blocks which are movable or adjustable relative to each other, to engage with and to rotate or to drive fasteners or objects of various sizes or outer diameters.

However, the blocks are limited to slide along the recesses of the head, and may not be farther separated away from each other, such that the typical adjustable wrenches may not be used to rotate or to drive plumbing tubings of greater sizes or outer diameters.

U.S. Pat. No. 5,746,097 to McCann and U.S. Pat. No. 6,167,784 to Lin disclose two further typical adjustable wrenches each comprising a pivotal jaw rotatably or pivotally attached onto a fixed jaw or a handle, to allow the pivotal jaw to be rotated or pivoted relative to the fixed jaw, and to rotate or to drive fasteners or objects of various sizes or outer diameters.

However, the pivotal jaws are rotatably or pivotally attached onto the fixed jaws or the handle with pivot pins, such that the pivotal jaws and the fixed jaws may not be farther rotated or separated away from each other, and such that the typical adjustable wrenches may not be used to rotate or to drive plumbing tubings of greater sizes or outer diameters.

In addition, the pivotal jaws are required to be formed with a receiving space therein and defined between two pivot lobes, to rotatably or pivotally receive the fixed jaws, and to allow the pivotal jaws and the fixed jaws or the handle to be rotatably or pivotally coupled together. The pivotal jaws are thus required to be formed with a greater width or thickness to allow the receiving space to be formed therein, such that the pivot jaws may have a greatly increased weight.

The present invention has arisen to mitigate and/or obviate the afore-described disadvantages of the conventional adjustable wrenches.

### SUMMARY OF THE INVENTION

The primary objective of the present invention is to provide an adjustable wrench for driving fasteners or objects of various sizes or outer diameters.

The other objective of the present invention is to provide an adjustable wrench having no oblong holes or channels required to be formed therein, to prevent the strength of the adjustable wrench from being decreased, or to allow the strength of the adjustable wrench to be suitably increased.

In accordance with one aspect of the invention, there is provided an adjustable wrench comprising a handle including a front portion having a fixed jaw provided thereon, and including a middle portion, a follower, at least one lever pivotally coupling the follower to the handle, to allow the follower to be pivoted relative to the handle, a pivotal jaw including a first end, and at least one link pivotally coupling the first end of the pivotal jaw to the follower, to allow the pivotal jaw to be pivoted relative to the follower, and to allow objects to be grasped between the fixed jaw and the pivotal jaw, and to be driven by the handle in an active direction.

The follower is a gear pivotally coupled between the handle and the first end of the pivotal jaw. The pivotal jaw includes a number of teeth provided on the first end thereof for engaging with the gear. The handle includes a number of teeth provided on the middle portion thereof for engaging with the gear.

The handle includes a number of projections provided on the front portion thereof for frictionally engaging with the objects. One or more spacers may further be provided and disposed between the link and the pivotal jaw, to solidly couple the pivotal jaw and the follower together.

The pivotal jaw includes a first engaging surface and at least one second engaging surface provided thereon, for engaging with the objects, and for grasping the objects between the fixed jaw and the pivotal jaw. The first and at least one second engaging surfaces of the pivotal jaw 30 include an included angle θ less than 90 degrees.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an adjustable wrench in accordance with the present invention;

FIG. 2 is a perspective view of the adjustable wrench;

FIG. 3 is a plan schematic view of the adjustable wrench, illustrating the operation of the adjustable wrench;

FIGS. 4, 5 are plan schematic views similar to FIG. 3, illustrating the operation of the adjustable wrench; and

FIG. 6 is a plan schematic view similar to FIGS. 3-5, illustrating the other application of the adjustable wrench.

### DETAILED DESCRIPTION OF THE PREFERRED EMBODIMENT

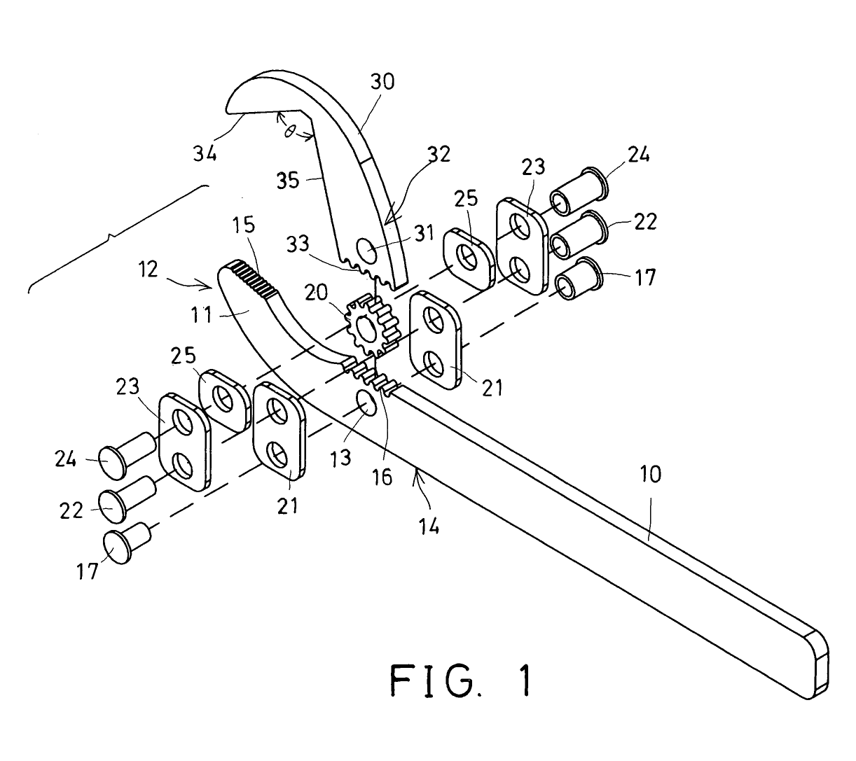

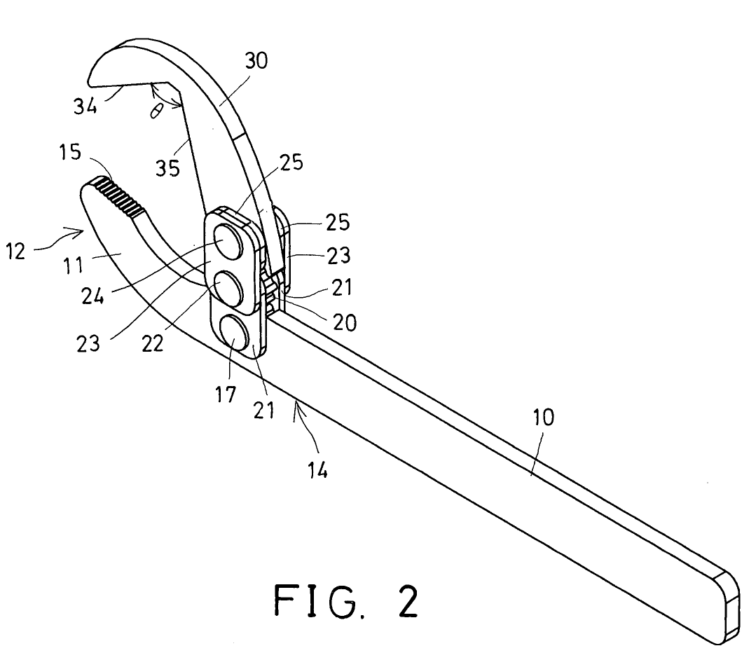

Referring to the drawings, and initially to FIGS. 1-3, an adjustable wrench in accordance with the present invention comprises a handle 10 including a fixed jaw 11 formed or provided on a front portion 12 of the handle 10, and an orifice 13 formed or provided in a middle portion 14 or in the front portion 12 of the handle 10, or located close to the front portion 12 of the handle 10.

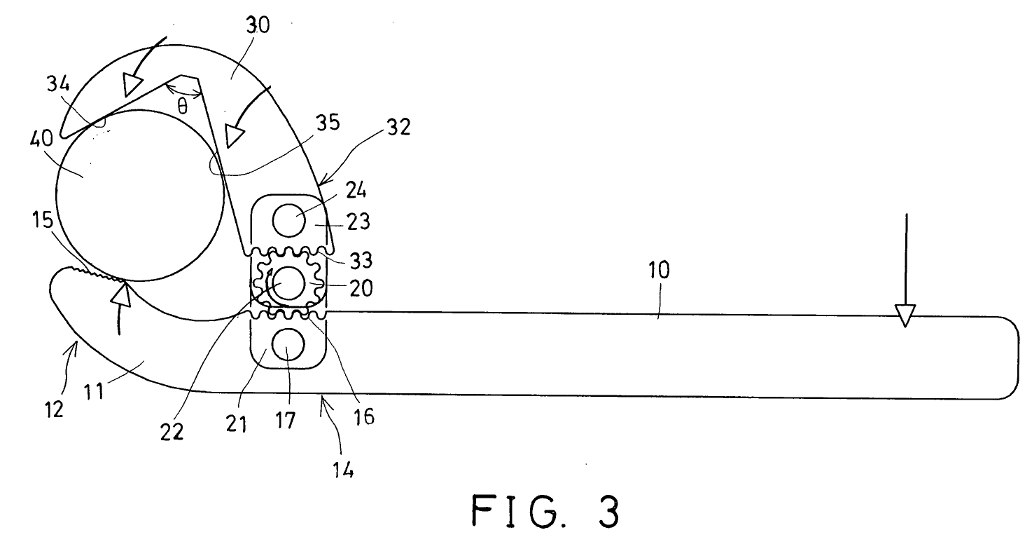

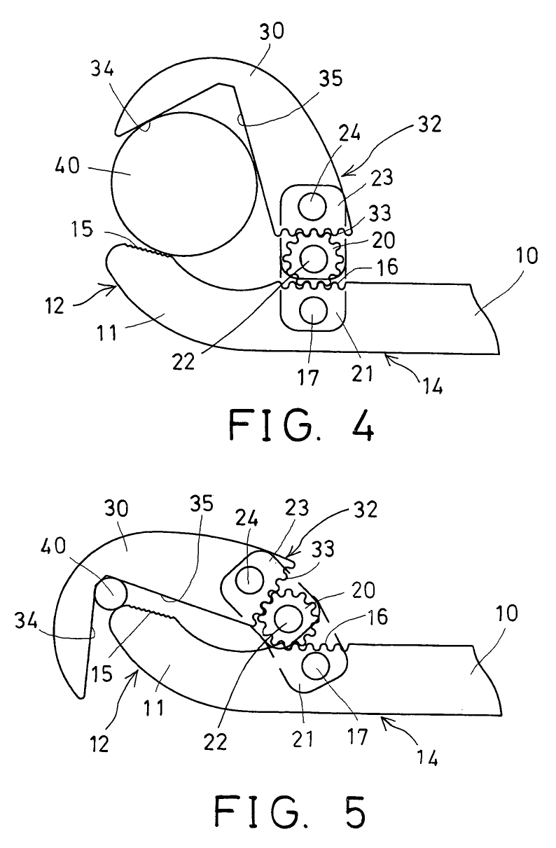

The handle 10 includes a serrated surface or a number of teeth or projections 15 formed or provided on the front portion 12 or the fixed jaw 11 of the handle 10 for frictionally or solidly engaging. with fasteners or objects 40 (FIGS. 3-5) of various sizes or outer diameters, and includes a number of projections or teeth 16 formed or provided on the middle portion 14 of the handle 10, for engaging with a follower 20, such as a wheel or a roller or a gear 20.

The follower or the gear 20 may be rotatably or pivotally attached or coupled to the fixed jaw 11 or the handle 10 with one or more, such as two levers 21 and two pivot pins 17, 22 which may be engaged through the levers 21 and the fixed jaw 11 or the handle 10 and the gear 20 respectively, to allow the gear 20 to be suitably engaged with the teeth 16 of the handle 10, and to be slightly rotated or pivoted relative to the fixed jaw 11 or the handle 10.

A pivotal jaw 30 includes an aperture 31 formed or provided in one end 32 thereof for rotatably or pivotally attaching or coupling to the follower or the gear 20 with one or more, such as two links 23 and the pivot pins 24, 22 which may be engaged through the pivotal jaw 30 and the links 23 and the gear 20 respectively, to allow the pivotal jaw 30 to be slightly rotated or pivoted relative to the gear 20.

The pivotal jaw 30 preferably includes a number of projections or teeth 33 formed or provided on the end 32, for engaging with the follower or the gear 20, and thus for allowing the pivotal jaw 30 and the gear 20 and the fixed jaw 11 or the handle 10 to be suitably and pivotally coupled together with the levers 21 and the links 23. It is preferable that one or more inserts or spacers 25 may further be provided and disposed between the links 23 and the pivotal jaw 30, to allow the pivotal jaw 30 and the gear 20 to be solidly and pivotally coupled together, and to prevent the pivotal jaw 30 and the gear 20 from moving sidewise relative to each other.

The pivotal jaw 30 includes one or more engaging surfaces 34, 35, such as curved or flat surfaces 34, 35 formed or provided on the other end thereof or located distal to the one end 32 thereof, for engaging with the fasteners or objects 40, and for grasping or gripping the fasteners or objects 40 between the fixed jaw 11 and the pivotal jaw 30. It is preferable that the first and the second engaging surfaces 34, 35 of the pivotal jaw 30 include an included angle θ less than 90 degrees (FIGS. 1-6), to allow the fasteners or objects 40 to be solidly grasped or gripped between the fixed jaw 11 and the pivotal jaw 30.

In operation, as shown in FIGS. 3-5, the fasteners or objects 40 of various sizes or outer diameters may be disposed between the fixed jaw 11 and the pivotal jaw 30, and may be solidly grasped or gripped between the fixed jaw 11 and the pivotal jaw 30 when the handle 10 is rotated in one or active direction, such as clockwise direction. The handle 10 and the fixed jaw 11 and the pivotal jaw 12 may be rotated freely relative to the objects 40 in a reverse direction, such as counterclockwise direction, for allowing the fasteners or objects 40 of various sizes or outer diameters to be rotated or driven by the handle 10 in the active direction.

When the handle 10 and the fixed jaw 11 and the pivotal jaw 12 are disposed or turned up-side-down relative to the objects 40, the objects 40 may be rotated or driven in the reverse direction by the handle 10.

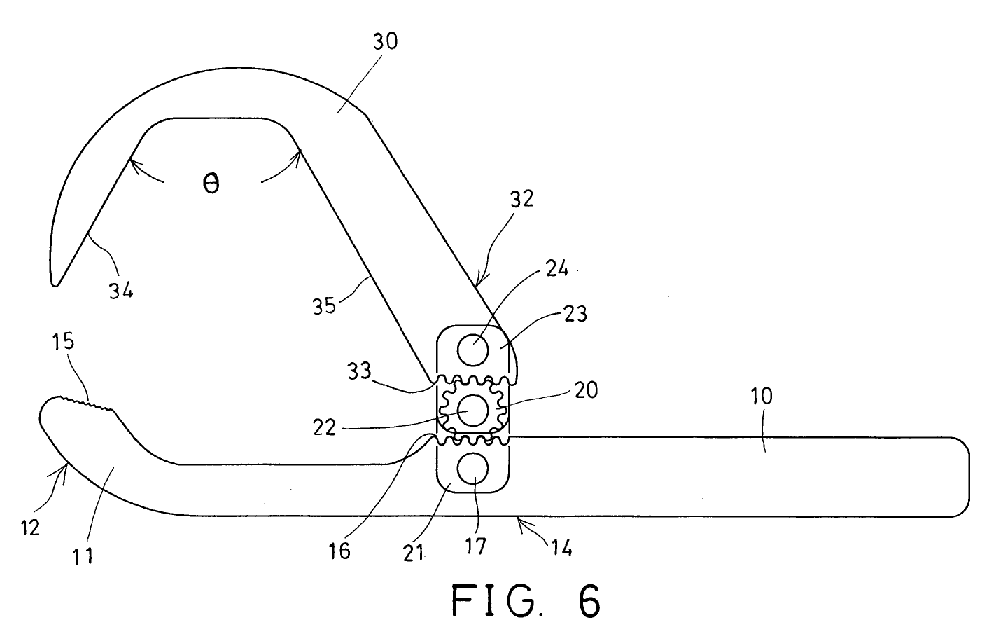

As shown in FIG. 6, when the pivotal jaw 30 includes a greater or an increased length, the adjustable wrench may also be used to rotate or to drive the oil filters of vehicles (not shown).

Accordingly, the adjustable wrench in accordance with the present invention may be provided for driving fasteners or objects of various sizes or outer diameters, and may have no oblong holes or channels required to be formed therein, to prevent the strength of the adjustable wrench from being decreased, or to allow the strength of the adjustable wrench to be suitably increased.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adjustable wrench comprising:
a handle including a front portion having a fixed jaw provided thereon, and including a middle portion,
a follower,
at least one lever pivotally coupling said follower to said handle, to allow said follower to be pivoted relative to said handle,
a pivotal jaw including a first end, and
at least one link pivotally coupling said first end of said pivotal jaw to said follower, to allow said pivotal jaw to be pivoted relative to said follower, and to allow objects to be grasped between said fixed jaw and said pivotal jaw, and to be driven by said handle in an active direction.

2. The adjustable wrench as claimed in claim 1, wherein said follower is a gear pivotally coupled between said handle and said first end of said pivotal jaw.

3. The adjustable wrench as claimed in claim 2, wherein said pivotal jaw includes a plurality of teeth provided on said first end thereof for engaging with said gear.

4. The adjustable wrench as claimed in claim 2, wherein said handle includes a plurality of teeth provided on said middle portion thereof for engaging with said gear.

5. The adjustable wrench as claimed in claim 1, wherein said handle includes a plurality of projections provided on said front portion thereof for frictionally engaging with the objects.

6. The adjustable wrench as claimed in claim 1 further comprising at least one spacer disposed between said at least one link and said pivotal jaw, to solidly couple said pivotal jaw and said follower together.

7. The adjustable wrench as claimed in claim 1, wherein said pivotal jaw includes a first engaging surface and at least one second engaging surface provided thereon, for engaging with the objects, and for grasping the objects between said fixed jaw and said pivotal jaw.

8. The adjustable wrench as claimed in claim 7, wherein said first and at least one second engaging surfaces of said pivotal jaw 30 include an included angle θ less than 90 degrees.
